(19) United States
(12) Patent Application Publication
(10) Pub. No.: US 2026/0287531 A1
(43) Pub. Date: Sep. 24, 2026

(54) METHODS FOR QUANTIFYING PRECURSOR COMPOUNDS AND RELATED SYSTEMS AND RELATED COMPOSITIONS

(71) Applicant: ENTEGRIS, INC., Billerica, MA (US)

(72) Inventor: Drew Michael Hood, Newtown, CT (US)

(21) Appl. No.: 19/571,438

(22) Filed: Mar. 18, 2026

Related U.S. Application Data
(60) Provisional application No. 63/773,862, filed on Mar. 18, 2025.

(51) Int. Cl. G01N 24/08

(52) U.S. Cl. CPC G01N 24/088

(57) ABSTRACT

Methods useful for quantifying an alkyl aluminum compound using aluminum amidinate, and related systems and related compositions are provided. The method comprises contacting a composition comprising a reaction product and an alkyl aluminum compound, with a carbodiimide compound, to form an aluminum amidinate. The carbodiimide compound selectively reacts with the alkyl aluminum compound over the reaction product. The method comprises analyzing the composition using ¹H NMR to determine a purity of the reaction product.

### CROSS-REFERENCE TO RELATED APPLICATIONS

This application claims the benefit under 35 USC 119 of U.S. Provisional Patent Application No. 63/773,862, filed Mar. 18, 2025, the disclosure of which is hereby incorporated herein by reference in its entirety.

### FIELD

The present disclosure relates to methods for quantifying precursor compounds and related systems and related compositions.

### BACKGROUND

Microelectronic applications, including semiconductor applications, require high purity precursors. Synthetic routes for making precursors can result in producing impurities that do not allow for use of analytical techniques to determine purity, among other things.

### SUMMARY

Some embodiments relate to a method. In some embodiments, the method comprises contacting a composition comprising a reaction product and an alkyl aluminum compound, with a carbodiimide compound, to form an aluminum amidinate. In some embodiments, the carbodiimide compound selectively reacts with the alkyl aluminum compound over the reaction product. In some embodiments, the method comprises analyzing the composition to determine a purity of the reaction product.

Some embodiments relate to a method. In some embodiments, the method comprises obtaining an alkyl aluminum compound. In some embodiments, the method comprises contacting the alkyl aluminum compound with a reagent to form a composition comprising a reaction product and an unconverted amount of the alkyl aluminum compound. In some embodiments, the method comprises contacting the composition with a carbodiimide compound to form an aluminum amidinate. In some embodiments, the carbodiimide compound selectively reacts with the unconverted amount of the alkyl aluminum compound over the reaction product. In some embodiments, the method comprises analyzing the composition to determine a purity of the reaction product.

Some embodiments relate to a composition. In some embodiments, the composition comprises an aluminum precursor. In some embodiments, the aluminum precursor comprises a compound of the formula:

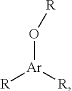

where:
R independently comprises an alkyl.

In some embodiments, the composition comprises less than 5% by weight of an alkyl aluminum compound based on a total weight of the composition.

Some embodiments relate to an article. In some embodiments, the article comprises a substrate. In some embodiments, the substrate has a first surface portion comprising a metal. In some embodiments, the substrate has a second surface portion comprising a non-metal. In some embodiments, the article comprises a layer. In some embodiments, the layer comprises a reaction product. In some embodiments, the reaction product comprises a compound of the formula:

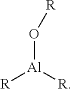

In some embodiments, each R is independently an alkyl. In some embodiments, the layer is located on the second surface portion.

### BRIEF DESCRIPTION OF THE DRAWINGS

FIG. 1 is a flowchart of a method 100 for forming an aluminum amidinate, according to some embodiments.

FIG. 2 is a flowchart of a method 200 for determining the purity of a reaction product, according to some embodiments.

FIGS. 3A and 3B are two halves of a graphical representation of a 1H NMR spectrum of a composition, according to some embodiments.

FIGS. 4A and 4B are two halves of a graphical representation of a 1H NMR spectrum of a composition, according to some embodiments.

FIGS. 5A and 5B are two halves of a graphical representation of a 1H NMR spectrum of a composition, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Any prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “contacting” refers to bringing two or more components into immediate or close proximity, or into direct contact.

As used herein, the term “alkyl” refers to a hydrocarbyl having from 1 to 30 carbon atoms. The alkyl may be attached via a single bond. An alkyl having n carbon atoms may be designated as a “Cₙ alkyl.” For example, a “C₃ alkyl” may include n-propyl and isopropyl. An alkyl having a range of carbon atoms, such as 1 to 30 carbon atoms, may be designated as a C₁-C₃₀ alkyl. In some embodiments, the alkyl is linear. In some embodiments, the alkyl is branched. In some embodiments, the alkyl is substituted. In some embodiments, the alkyl is unsubstituted. In some embodiments, the alkyl comprises or is selected from the group consisting of at least one of a C₁-C₃₀ alkyl, C₁-C₂₉ alkyl, C₁-C₂₈ alkyl, C₁-C₂₇ alkyl, C₁-C₂₇ alkyl, C₁-C₂₆ alkyl, C₁-C₂₅ alkyl, C₁-C₂₄ alkyl, C₁-C₂₃ alkyl, C₁-C₂₂ alkyl, C₁-C₂₁ alkyl, C₁-C₂₀ alkyl, C₁-C₁₉ alkyl, C₁-C₁₈ alkyl, C₁-C₁₇ alkyl, C₁-C₁₆ alkyl, C₁-C₁₅ alkyl, C₁-C₁₄ alkyl, C₁-C₁₃ alkyl, C₁-C₁₂ alkyl, C₁-C₁₁ alkyl, C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₁-C₂ alkyl, a C₂-C₃₀ alkyl, a C₃-C₃₀ alkyl, a C₄-C₃₀ alkyl, a C₅-C₃₀ alkyl, a C₆-C₃₀ alkyl, a C₇-C₃₀ alkyl, a C₈-C₃₀ alkyl, a C₉-C₃₀ alkyl, a C₁₀-C₃₀ alkyl, a C₁₁-C₃₀ alkyl, a C₁₂-C₃₀ alkyl, a C₁₃-C₃₀ alkyl, a C₁₄-C₃₀ alkyl, a C₁₅-C₃₀ alkyl, a C₁₆-C₃₀ alkyl, a C₁₇-C₃₀ alkyl, a C₁₈-C₃₀ alkyl, a C₁₉-C₃₀ alkyl, a C₂₀-C₃₀ alkyl, a C₂₁-C₃₀ alkyl, a C₂₂-C₃₀ alkyl, a C₂₃-C₃₀ alkyl, a C₂₄-C₃₀ alkyl, a C₂₅-C₃₀ alkyl, a C₂₆-C₃₀ alkyl, a C₂₇-C₃₀ alkyl, a C₂₈-C₃₀ alkyl, a C₂₉-C₃₀ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₈ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof. In some embodiments, the term “alkyl” refers generally to alkyls, alkenyls, alkynyls, and/or cycloalkyls.

Systems and methods for quantifying precursors are provided herein. The synthesis of some precursors can make it difficult to determine a purity of the precursor because, for example, the synthesis of the precursor also produces at least one impurity, which is not (easily) separated from the precursor during post-synthesis processing and/or which is not capable of being detected using analytic techniques because, for example, the at least one impurity is chemically similar to the precursor. In either of these scenarios, among others, the purity of the precursor, and thus the amount of the at least one impurity, cannot be determined. The systems and methods disclosed herein overcome at least this challenge by providing systems and methods for derivatizing the at least one impurity, such that, the chemical identify and/or quantification of the at least one impurity can be performed via analytical techniques.

Some embodiments, for example, relate to the synthesis of alkyl aluminum alkoxide compounds (precursors), such as, for example and without limitation, dimethyl aluminum isopropoxide (DMAI), among others. The synthesis of alkyl aluminum alkoxide compounds can also result in the presence of impurities—either as by-products, excess or unreacted reagents, or any combination thereof—such as, for example and without limitation, trimethyl aluminum and other alkyl aluminum compounds. Due to the chemical similarity of the alkyl aluminum alkoxide compound precursor and the alkyl aluminum compound impurity, the purity of the alkyl alkoxide compound precursor cannot be determined. For example, in some embodiments, when ¹H NMR is used, the peak for the precursor and the peak for the impurity are indistinguishable. To determine precursor purity, the systems and methods disclosed herein derivatize the impurity, using a reagent that selectively reacts with the impurity and not the precursor, such that, the precursor and the impurity are distinguishable using analytical techniques and thus precursor purity can be determined.

Although ¹H NMR is disclosed herein, it will be appreciated that other analytical techniques for measuring purity can be employed including, for example and without limitation, gas chromatography (GC) analysis, among others. Non-limiting examples of GC analysis include, for example and without limitation, at least one of Gas Chromatography-Mass Spectrometry (GC-MS), Gas Chromatography-Flame Ionization Detector (GC-FID), Gas Chromatography-Thermal Conductivity Detector (GC-TCD), Gas Chromatography-Electron Capture Detector (GC-ECD), or any combination thereof.

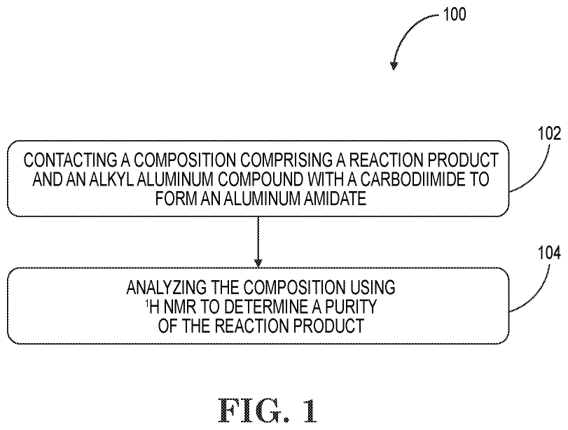

FIG. 1 is a flowchart of a method 100 for determining purity, according to some embodiments. As shown in FIG. 1, in some embodiments, the method 100 for determining purity comprises one or more of the following steps: contacting 102 a composition comprising a reaction product and an alkyl aluminum compound, with a carbodiimide compound (DIC), to form an aluminum amidinate 102; and analyzing 104 the composition to determine a purity of the reaction product.

At step 102, in some embodiments, the method 100 comprises contacting a composition comprising a reaction product and an alkyl aluminum compound, with a carbodiimide compound, to form an aluminum amidinate.

In some embodiments, the contacting comprises bringing the composition and the carbodiimide compound into close or immediate proximity. In some embodiments, the contacting comprises bringing the composition and the carbodiimide compound into direct physical contact. In some embodiments, the contacting comprises adding the composition to the carbodiimide compound, or vice versa. In some embodiments, the contacting comprises mixing the composition and the carbodiimide compound. In some embodiments, the contacting comprises stirring the composition and the carbodiimide compound. In some embodiments, the contacting comprises agitating the composition and the carbodiimide compound. In some embodiments, the contacting comprises flowing the composition through a vessel containing the carbodiimide compound, or vice versa. In some embodiments, the contacting comprises adding the carbodiimide compound to the composition in stoichiometric excess of the alkyl aluminum compound. In some embodiments, the contacting comprises derivatizing the alkyl aluminum compound to produce an aluminum amidinate compound. In some embodiments, the contacting comprises selectively reacting the carbodiimide compound and the alkyl aluminum compound. In some embodiments, the contacting does not comprise reacting the carbodiimide compound with the reaction product.

The reaction product can comprise the precursor. For example, in some embodiments, the reaction product comprises a compound of the formula:

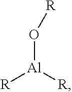

where:
each R is independently an alkyl.

In some embodiments, each R comprises the same alkyl. In some embodiments, each R comprises a different alkyl. In some embodiments, at least two R are the same. In some embodiments, at least two R are different.

In some embodiments, the reactor product comprises a compound of the formula:

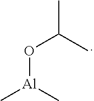

In some embodiments, the reaction product is a product of a reaction between trimethyl aluminum compound and 2-propanol to form dimethylaluminum isopropoxide (DMAI).

The alkyl aluminum compound can be a compound that cannot be distinguished from the precursor using analytical techniques, such as, for example and without limitation, 1H NMR and GC analysis, among others. For example, in some embodiments, the alkyl aluminum compound comprises a compound of the formula:

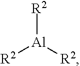

where:
each R² is independently an alkyl.

In some embodiments, each R² comprises the same alkyl. In some embodiments, each R² comprises a different alkyl. In some embodiments, at least two R² are same. In some embodiments, at least two R² are different.

In some embodiments, the alkyl aluminum compound comprises a compound of the formula:

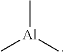

The carbodiimide compound can selectively react with the alkyl aluminum compound, relative to the reaction product, such as, for example, the alkyl aluminum alkoxide compound. In some embodiments, the carbodiimide compound selectively reacts with the alkyl aluminum compound over the reaction product. In some embodiments, the carbodiimide compound does not react with the reaction product. In some embodiments, the carbodiimide compound does not react with alkyl aluminum alkoxide compound. In some embodiments, the carbodiimide compound does not react with dimethylaluminum isopropoxide (DMAI).

In some embodiments, the carbodiimide compound comprises a compound of the formula:

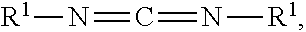

where:
each R¹ is independently an alkyl.

In some embodiments, each R¹ comprises the same alkyl. In some embodiments, each R¹ comprises a different alkyl. In some embodiments, at least two R¹ are same. In some embodiments, at least two R¹ are different.

In some embodiments, the carbodiimide compound comprises a compound of the formula:

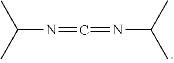

The aluminum amidinate compound is a reaction product of the alkyl aluminum compound and the carbodiimide compound. In some embodiments, the aluminum amidinate compound has resolved peaks when 1H NMR or GC analysis is used for determining purity. In some embodiments, the aluminum amidinate comprises a compound of the formula:

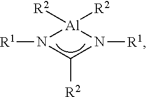

where:
each R¹ is independently an alkyl; and
each R² is independently an alkyl.

In some embodiments, each R¹ comprises the same alkyl. In some embodiments, each R¹ comprises a different alkyl. In some embodiments, at least two R¹ are same. In some embodiments, at least two R¹ are different.

In some embodiments, each R² comprises the same alkyl. In some embodiments, each R² comprises a different alkyl. In some embodiments, at least two R² are same. In some embodiments, at least two R² are different.

In some embodiments, R¹ and R² are same. In some embodiments, at least one R¹ and at least one R² are different. In some embodiments, R¹ and R² are different.

In some embodiments, the aluminum amidinate comprises a compound of the formula:

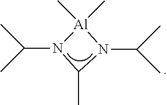

In some embodiments, 95% to 99.9% of the alkyl aluminum compound is converted to the aluminum amidinate. For example, in some embodiments, 96% to 99%, or 97% to 98% of the alkyl aluminum compound is converted to the aluminum amidinate. In some embodiments, 96% to 99.9%, 97% to 99.9%, 98% to 99.9%, or 99% to 99.9% of the alkyl aluminum compound is converted to the aluminum amidinate. In some embodiments, 95% to 99%, 95% to 98%, 95% to 97%, or 95% to 96% of the alkyl aluminum compound is converted to the aluminum amidinate. In some embodiments, the alkyl aluminum compound is converted in its entirety to the aluminum amidinate. In some embodiments, the percentage converted refers to a percentage by weight based on a total weight of the alkyl aluminum compound.

In some embodiments, at least 99% of the alkyl aluminum compound is converted to the aluminum amidinate. In some embodiments, at least 99.1%, at least 99.2%, at least 99.3%, at least 99.4%, at least 99.5%, at least 99.6%, at least 99.7%, at least 99.8%, at least 99.9%, at least 99.99%, at least 99.999%, or 100% of the alkyl aluminum compound is converted to the aluminum amidinate. In some embodiments, the percentage converted refers to a percentage by weight based on a total weight of the alkyl aluminum compound.

The carbodiimide can selectively react with the alkyl aluminum compound over the reaction product to, for example, permit conversion or derivatization of the alkyl aluminum compound to an aluminum amidinate for purposes of determining purity of the reaction product. For example, in some embodiments, the carbodiimide compound does not react with the reaction product. In some embodiments, the extent to which the carbodiimide compound reacts with the reaction product, if at all, is negligible or at least not detectable (e.g., below detection limits). In some embodiments, less than 5%, less than 4%, less than 3%, less than 2%, or less than 1% of the carbodiimide compound reacts with the reaction product. In some embodiments, the percentage is a percentage by weight based on a total weight of the carbodiimide compound. In some embodiments, the carbodiimide selectively reacts with the alkyl aluminum compound over the reaction product at a temperature of 20° C. to 30° C. (e.g., about 25° C.) for a duration of 12 hours to 36 hours (e.g., 24 hours).

In some embodiments, the composition comprises a low concentration of at least one impurity, such as, for example and without limitation, the alkyl aluminum compound. In some embodiments, the composition comprises, for example, 0.001% to 5% by weight of the at least one impurity based on a total weight of the composition, or any range or subrange between 0.001% and 5%. In some embodiments, the amount of the at least one impurity is at, below, or near the detection limit for 1H NMR spectrometer or GC analysis. In some embodiments, the composition comprises 0.001% to 5%, 0.001% to 4%, 0.001% to 3%, 0.001% to 2%, 0.001% to 1%, 0.001% to 0.1%, or 0.001% to 0.01% by weight of the at least one impurity based on the total weight of the composition. In some embodiments, the at least one impurity does not comprise the aluminum amidinate compound. In some embodiments, the at least one impurity comprises the alkyl aluminum compound.

In some embodiments, the composition comprises 95% to 99.9999% by weight of the reaction product based on the total weight of the composition, or any range or subrange between 95% and 99.9999%. For example, in some embodiments, the composition comprises 96% to 99.999%, 97% to 99.99%, or 98% to 99.9% by weight of the reaction product based on the total weight of the composition. In some embodiments, the composition comprises 96% to 99.9999%, 97% to 99.9999%, 98% to 99.9999%, 99% to 99.9999%, 99.9% to 99.9999%, 99.99% to 99.9999%, or 99.999% to 99.9999% by weight of the reaction product based on the total weight of the composition. In some embodiments, the composition comprises 95% to 99.999%, 95% to 99.99%, 95% to 99.9%, 95% to 99%, 95% to 98%, 95% to 97%, or 95% to 96% by weight of the reaction product based on the total weight of the composition.

At step 104, in some embodiments, the method 100 comprises analyzing the composition to determine a purity of the reaction product.

The analyzing can comprise applying analytical chemistry techniques to quantify and/or detect a presence of the aluminum amidinate compound or other impurity. The analyzing can be conducted using at least one of ¹H NMR, GC analysis, or any combination thereof. In some embodiments, the analyzing is conducted using ¹H NMR to determine purity. In some embodiments, the analyzing is conducting using Gas Chromatography-Mass Spectrometry (GC-MS) to determine purity. In some embodiments, the analyzing is conducted using Gas Chromatography-Flame Ionization Detector (GC-FID) to determine purity. In some embodiments, the analyzing is conducted using Gas Chromatography-Thermal Conductivity Detector (GC-TCD) to determine purity. In some embodiments, the analyzing is conducted using Gas Chromatography-Electron Capture Detector (GC-ECD) to determine purity. It will be appreciated that analytical techniques other than NMR and GC analysis can be employed, without departing from the scope of this disclosure.

In some embodiments, for example, the analyzing comprises performing ¹H NMR spectroscopy on the composition to produce a ¹H NMR spectrum; and analyzing the ¹H NMR spectrum to quantify an amount of the aluminum amidinate compound or other impurity. In some embodiments, the analyzing comprises quantifying at least one peak in correlation to the composition and the aluminum amidinate using ¹H NMR to determine the purity of the reaction product. In some embodiments, the analyzing comprises identifying aluminum amidinate peaks to quantify the alkyl aluminum compound. In some embodiments, the analyzing comprises quantifying the protons in aluminum amidinate. In some embodiments, the analyzing comprises quantifying the protons in the reaction product. In some embodiments, the analyzing comprises identifying each R peak to quantify the reaction product. In some embodiments, the analyzing comprises integrating the aluminum amidinate peaks. In some embodiments, the analyzing comprises integrating the area under the peaks of the ¹H NMR. In some embodiments, the analyzing comprises determining the molar concentration of the aluminum amidinate relative to the reaction product. In some embodiments, the molar concentration of the aluminum amidinate relative to the reaction product is in correlation to the molar concentration of the alkyl aluminum compound relative to the reaction product.

In some embodiments, when the composition is analyzed by ¹H NMR, a peak representing the aluminum amidinate compound is separate from a peak representing the reaction product (e.g., dimethylaluminum isopropoxide). In some embodiments, when the composition is analyzed by 1H NMR, a peak representing the aluminum amidinate compound is distinguishable from a peak representing the reaction product (e.g., dimethylaluminum isopropoxide). In some embodiments, when the composition is analyzed by ¹H NMR, a peak representing the aluminum amidinate compound is independently identifiable from a peak representing the reaction product (e.g., dimethylaluminum isopropoxide). In some embodiments, when the composition is analyzed by ¹H NMR, a peak representing the aluminum amidinate compound is shifted on a ¹H NMR spectrum relative to a peak representing the reaction product (e.g., dimethylaluminum isopropoxide).

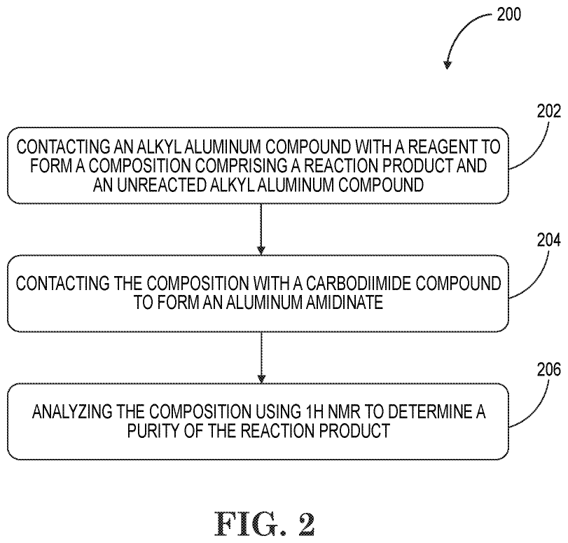

FIG. 2 is a flowchart of a method 200 for determining the purity of a reaction product, according to some embodiments. As shown in FIG. 2, the method 200 comprises the steps of contacting an alkyl aluminum compound with a reagent to form a composition comprising a reaction product and an unreacted alkyl aluminum compound 202; contacting the composition with a carbodiimide to form an aluminum amidate 204; and analyzing the composition to determine a purity of the reaction product 206.

At step 202, in some embodiments, the method 200 comprises the steps of contacting an alkyl aluminum compound with a reagent to form a composition comprising a reaction product and an alkyl aluminum compound (e.g., an unreacted alkyl aluminum compound).

In some embodiments, the contacting comprises bringing the alkyl aluminum compound and a reagent into close or immediate proximity. In some embodiments, the contacting comprises bringing the alkyl aluminum compound and a reagent into direct physical contact. In some embodiments, the contacting comprises adding the alkyl aluminum compound to a reagent, or vice versa. In some embodiments, the contacting comprises mixing the alkyl aluminum compound and a reagent. In some embodiments, the contacting comprises stirring the alkyl aluminum compound and a reagent. In some embodiments, the contacting comprises agitating the alkyl aluminum compound and a reagent. In some embodiments, the contacting comprises flowing the alkyl aluminum compound through a vessel containing a reagent, or vice versa. In some embodiments, the contacting comprises adding the reagent to the alkyl aluminum compound in stoichiometric excess of the alkyl aluminum compound.

In some embodiments, the alkyl aluminum compound comprises a compound of the formula:

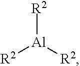

where:
each R² is independently an alkyl.

In some embodiments, each R² comprises the same alkyl. In some embodiments, each R² comprises a different alkyl. In some embodiments, at least two R² are same. In some embodiments, at least two R² are different.

In some embodiments, the reagent comprises at least one of a 2-propanol, an aluminum isopropoxide, or any combination thereof. In some embodiments, the reagent comprises a 2-propanol. In some embodiments, the reagent comprises aluminum isopropoxide.

In some embodiments, the reaction product comprises a compound of the formula:

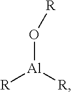

where:
each R is independently an alkyl.

In some embodiments, each R comprises the same alkyl. In some embodiments, each R comprises a different alkyl. In some embodiments, at least two R are the same. In some embodiments, at least two R are different.

Each R on the reaction product may be a substituent from the alkyl aluminum compound. For example, in some embodiments, trimethylaluminum compound, comprising the formula:

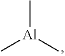

when contacted a reagent, 2-propanol, may form the reaction product dimethylaluminum isopropoxide (DMAI) comprising the formula:

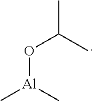

In some embodiments, the unconverted amount of the alkyl aluminum compound is 0.01% to 5% of the composition, or any combination thereof. For example, in some embodiments, the unconverted amount of the alkyl aluminum compound is 0.1% to 4%, 0.5% to 3%, or 1% to 2% of the composition. In some embodiments, the unconverted amount of the alkyl aluminum compound is 0.1% to 5%, 0.5% to 5%, 1% to 5%, 2% to 5%, 3% to 5%, or 4% to 5% of the composition. In some embodiments, the unconverted amount of the alkyl aluminum compound is 0.01% to 4%, 0.01% to 3%, 0.01% to 2%, 0.01% to 1%, 0.01% to 0.5%, or 0.01% to 0.1% of the composition.

In some embodiments, the unconverted amount of the alkyl aluminum compound is less than 5% of the composition. In some embodiments, the unconverted amount of the alkyl aluminum compound is less than 4%, less than 3%, less than 2%, less than 1%, less than 0.5%, less than 0.1%, less than 0.05%, or less than 0.01%, of the composition.

At step 204, in some embodiments, the method 200 comprises contacting the composition with a carbodiimide to form an aluminum amidate.

In some embodiments, the contacting comprises bringing the composition and the carbodiimide compound into close or immediate proximity. In some embodiments, the contacting comprises bringing the composition and the carbodiimide compound into direct physical contact. In some embodiments, the contacting comprises adding the composition to the carbodiimide compound, or vice versa. In some embodiments, the contacting comprises mixing the composition and the carbodiimide compound. In some embodiments, the contacting comprises stirring the composition and the carbodiimide compound. In some embodiments, the contacting comprises agitating the composition and the carbodiimide compound. In some embodiments, the contacting comprises flowing the composition through a vessel containing a carbodiimide compound, or vice versa. In some embodiments, the contacting comprises adding the carbodiimide compound to the composition in stoichiometric excess of the composition.

In some embodiments, the carbodiimide compound comprises a compound of the formula:

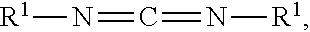

where:
each R¹ is independently a C₃ alkyl, a C₄ alkyl, or a C₆ alkyl.

In some embodiments, each R¹ is independently a isopropyl, a tert-butyl, or a cyclohexyl.

In some embodiments, each R¹ comprises the same alkyl. In some embodiments, each R¹ comprises a different alkyl. In some embodiments, at least two R¹ are same. In some embodiments, at least two R¹ are different.

In some embodiments, the carbodiimide compound selectively reacts with the unreacted alkyl aluminum compound over the reaction product. In some embodiments, the carbodiimide compound does not with the reaction product.

In some embodiments, the aluminum amidinate comprises a compound of the formula:

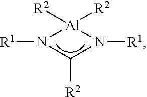

where:
each R¹ is independently a C₃ alkyl, a C₄ alkyl, or a C₆ alkyl; and
each R² is independently a C₁ alkyl.

In some embodiments, each R¹ is independently an isopropyl, a tert-butyl, or a cyclohexyl. In some embodiments, each R² is independently a methyl.

In some embodiments, each R¹ comprises the same alkyl. In some embodiments, each R¹ comprises a different alkyl. In some embodiments, one R¹ comprises a different alkyl.

In some embodiments, each R² comprises the same alkyl. In some embodiments, each R² comprises a different alkyl. In some embodiments, one R² comprises a different alkyl.

In some embodiments, at least 99.9% of the alkyl aluminum compound is converted to the aluminum amidinate. In some embodiments, at least 99.99%, at least 99.999%, or 100% of the alkyl aluminum compound is converted to the aluminum amidinate.

At step 206, in some embodiments, the method 200 comprises analyzing the composition using ¹H NMR to determine a purity of the reaction product. In some embodiments, the analyzing comprises quantifying at least one peak in correlation to the composition and the aluminum amidinate using ¹H NMR to determine the purity of the reaction product. In some embodiments, the analyzing comprises identifying aluminum amidinate peaks to quantify the unconverted amount of the alkyl aluminum compound. As detailed above, in some embodiments, analytical techniques other than NMR can be employed, such as, for example and without limitation, GC analysis, among others.

In some embodiments, the analyzing comprises separating at least one characteristic peak. The characteristic peak is defined for at least one of the reaction product, the carbodiimide compound, the aluminum amidinate, or any combination thereof. In some embodiments, the analyzing comprises separating at least one characteristic peak of the reaction product. In some embodiments, the analyzing comprises separating at least one characteristic peak of the carbodiimide compound. In some embodiments, the analyzing comprises separating at least one characteristic peak of the aluminum amidinate.

In some embodiments, the analyzing comprises quantifying the protons in aluminum amidinate. In some embodiments, the analyzing comprises quantifying the protons in the reaction product. In some embodiments, the analyzing comprises identifying each R peak to quantify the reaction product, as described herein. In some embodiments, the analyzing comprises integrating the aluminum amidinate peaks. In some embodiments, the analyzing comprises integrating the reaction product peaks. In some embodiments, the analyzing comprises determining the molar concentration of the aluminum amidinate relative to the reaction product. In some embodiments, the molar concentration of the aluminum amidinate relative to the reaction product is in correlation to the molar concentration of the unconverted amount of the alkyl aluminum compound relative to the reaction product.

Some embodiments relate to a composition. In some embodiments, the composition comprises an aluminum precursor. In some embodiments, the aluminum precursor comprises a compound of the formula:

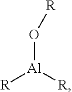

where:
each R is independently an alkyl.

In some embodiments, each R comprises the same alkyl. In some embodiments, each R comprises a different alkyl. In some embodiments, at least two R are the same. In some embodiments, at least two R are different.

In some embodiments, the aluminum precursor comprises a compound of the formula:

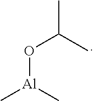

In some embodiments, the aluminum precursor has a purity of 95% to 99.9% as measured by ¹H NMR, or any range or subrange between 95% and 99.9%. For example, in some embodiments, the aluminum precursor has a purity of 96% to 99%, or 97% to 98% as measured by ¹H NMR. In some embodiments, the aluminum precursor has a purity of 96% to 99.9%, 97% to 99.9%, 98% to 99.9%, or 99% to 99.9% as measured by ¹H NMR. As detailed above, in some embodiments, analytical techniques other than NMR can be employed, such as, for example and without limitation, GC analysis, among others.

In some embodiments, the aluminum precursor has a purity of 99.9% to 99.999% as measured by ¹H NMR, or any range or subrange between 99.9% and 99.999%. For example, in some embodiments, the aluminum precursor has a purity of 99.9% to 99.99%, or 99.99% to 99.999% as measured by ¹H NMR. As detailed above, in some embodiments, analytical techniques other than NMR can be employed, such as, for example and without limitation, GC analysis, among others.

In some embodiments, the aluminum precursor has a purity of at least 99.9% as measured by ¹H NMR. In some embodiments, the aluminum precursor has a purity of at least 99.99%, at least 99.999%, or 100% as measured by ¹H NMR. As detailed above, in some embodiments, analytical techniques other than NMR can be employed, such as, for example and without limitation, GC analysis, among others.

In some embodiments, the composition comprises less than 5%, less than 4%, less than 3%, less than 2%, less than 1%, less than 0.1%, less than 0.01%, or less than 0.001% by weight of at least one impurity based on a total weight of the composition. In some embodiments, the at least one impurity comprises an alkyl aluminum compound (e.g., trimethyl aluminum, etc.). In some embodiments, the composition comprises, for example, 0.001% to 5% by weight of the at least one impurity based on a total weight of the composition, or any range or subrange between 0.001% and 5%. In some embodiments, the amount of the at least one impurity is at, below, or near the detection limit for ¹H NMR spectrometer or GC analysis. In some embodiments, the composition comprises 0.001% to 5%, 0.001% to 4%, 0.001% to 3%, 0.001% to 2%, 0.001% to 1%, 0.001% to 0.1%, or 0.001% to 0.01% by weight of the at least one impurity based on the total weight of the composition. In some embodiments, the at least one impurity does not comprise the aluminum amidinate compound.

In some embodiments, the aluminum precursor may be deposited on a substrate. For example, the aluminum precursor may be used to deposit on a substrate by one or more deposition processes. Examples of deposition processes include, without limitation, at least one of a chemical vapor deposition (CVD) process, a digital or pulsed chemical vapor deposition process, a plasma-enhanced cyclical chemical vapor deposition process (PECCVD), a flowable chemical vapor deposition process (FCVD), an atomic layer deposition (ALD) process, a thermal atomic layer deposition, a plasma-enhanced atomic layer deposition (PEALD) process, a metal organic chemical vapor deposition (MOCVD) process, a plasma-enhanced chemical vapor deposition (PECVD) process, or any combination thereof.

Some embodiments relate to an article. The article may comprise a substrate. The substrate may comprise at least one of Si, Co, Cu, Al, W, WN, WC, TIN, Mo, MoC, SiO₂, W, SiN, WCN, Al₂O₃, AlN, ZrO₂, La₂O₃, TaN, RuO₂, IrO₂, Nb₂O₃, Y₂O₃, hafnium oxide, or any combination thereof.

The substrate may have a first surface portion comprising a metal and a second surface portion comprising a non-metal. In some embodiments, the metal comprises an aluminum, a ruthenium, a tungsten, a tantalum, a molybdenum, a titanium, a copper, a cobalt, or any combination thereof. In some embodiments, the metal comprises a tungsten, a tantalum nitride, a titanium nitride, an aluminum oxide, aluminum nitride, or any combination thereof. In some embodiments, the second surface portion comprises a non-metal. In some embodiments, the non-metal comprises a silicon dioxide.

The article may comprise a layer. The layer may comprise a reaction product. In some embodiments, the reaction product may be the reaction product disclosed herein. The layer may be located on the second surface portion.

Any one or more of the embodiments disclosed herein shall be understood to be combinable without departing from the scope or spirit of the disclosure.

### Example 1

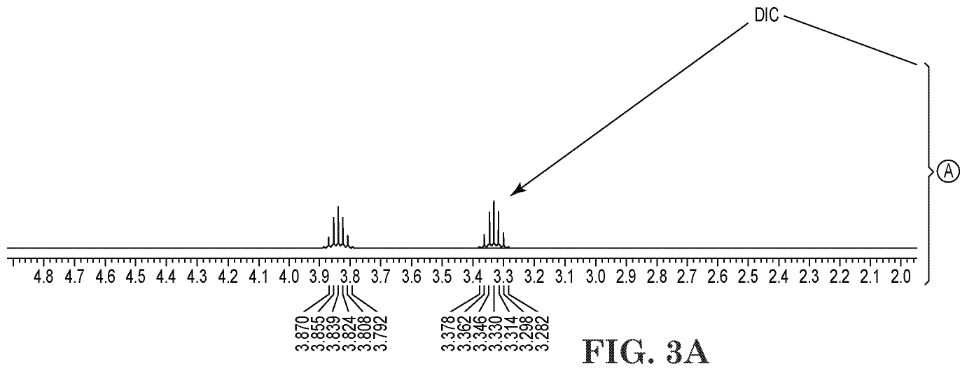

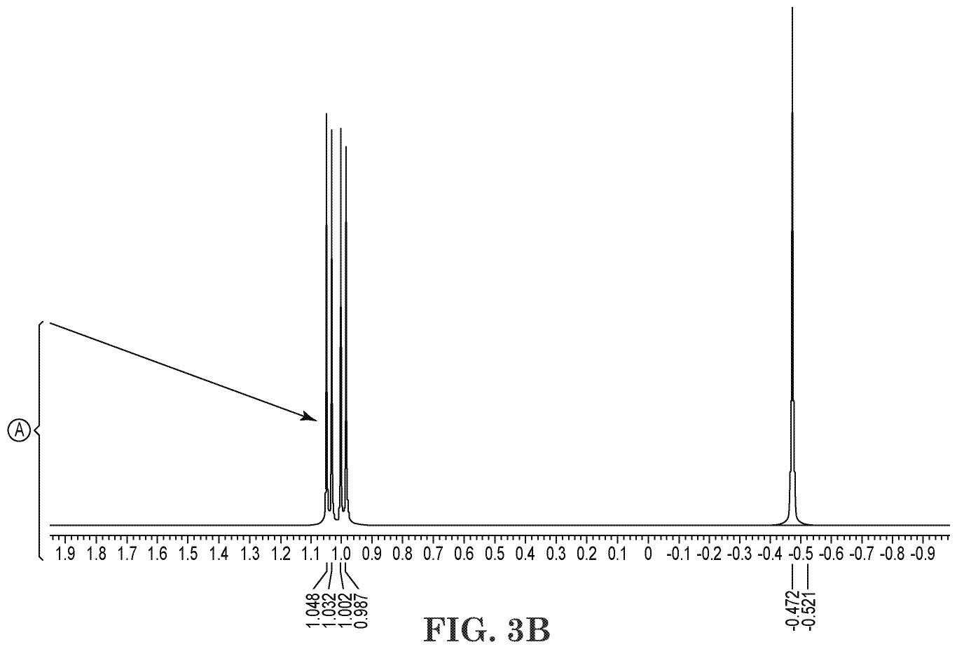

FIG. 3 is a graphical representation of a ¹H NMR spectrum of a composition, according to some embodiments. A composition, according to some embodiments, described herein, comprising dimethylaluminum isopropoxide (DMAI) and trimethylaluminum (TMA) was prepared. The composition was contacted with carbodiimide compound in stoichiometric excess at room temperature for over 24 hours. The composition was analyzed using ¹H NMR to determine a purity of the dimethylaluminum isopropoxide. As shown in FIG. 3, the carbodiimide compound peaks are identified.

### Comparative Example 1

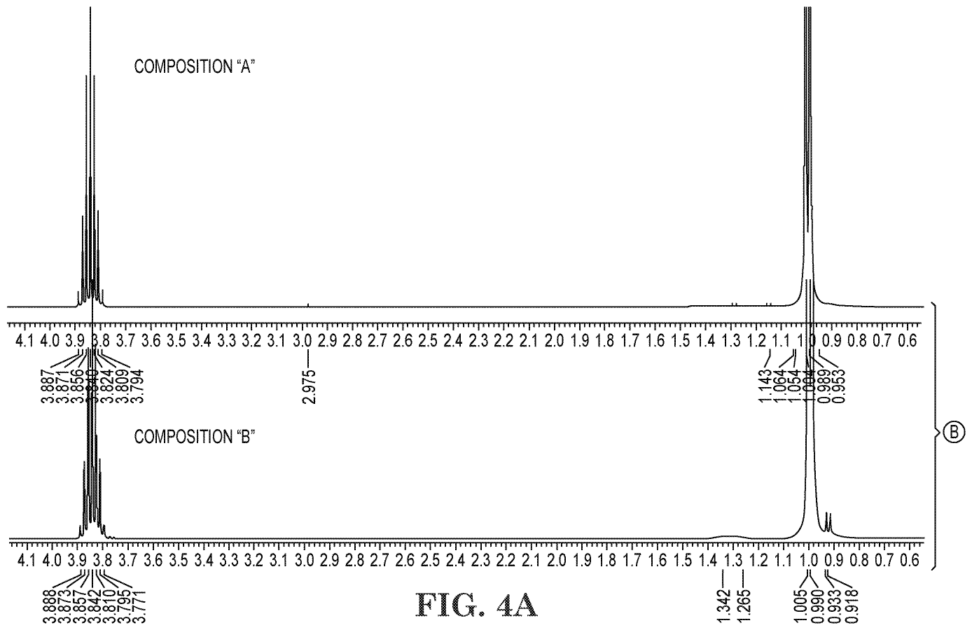

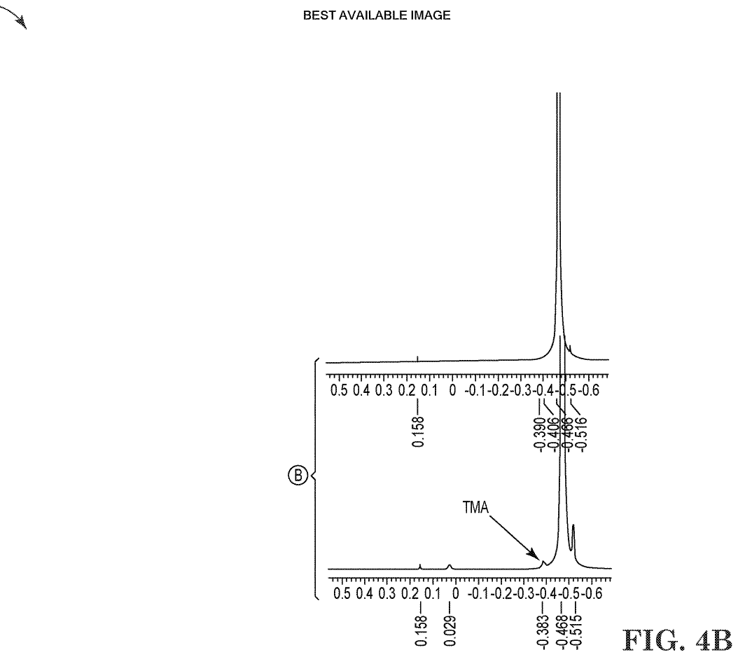

FIG. 4 is a graphical representation of a ¹H NMR spectrum of a composition, according to some embodiments. Composition “A” and a composition “B”, according to some embodiments, described herein, comprising dimethylaluminum isopropoxide (DMAI) and trimethylaluminum (TMA) were prepared. Composition “A” was contacted with carbodiimide compound in stoichiometric excess at room temperature for a duration of 24 hours. Composition “B” was not contacted with carbodiimide compound. Composition “A” and Composition “B” were analyzed using ¹H NMR to determine a purity of the dimethylaluminum isopropoxide in each composition. As shown in FIG. 4, the carbodiimide compound peaks are identified in the top portion of FIG. 4 using composition “A”. In the bottom portion of FIG. 4, TMA peaks are identified in composition “B”. A schematic diagram representing the reaction scheme involved in preparation of composition “A” is provided below:

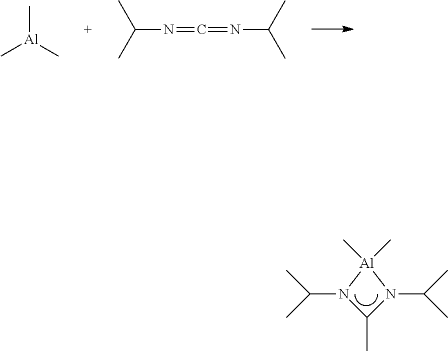

### Example 2

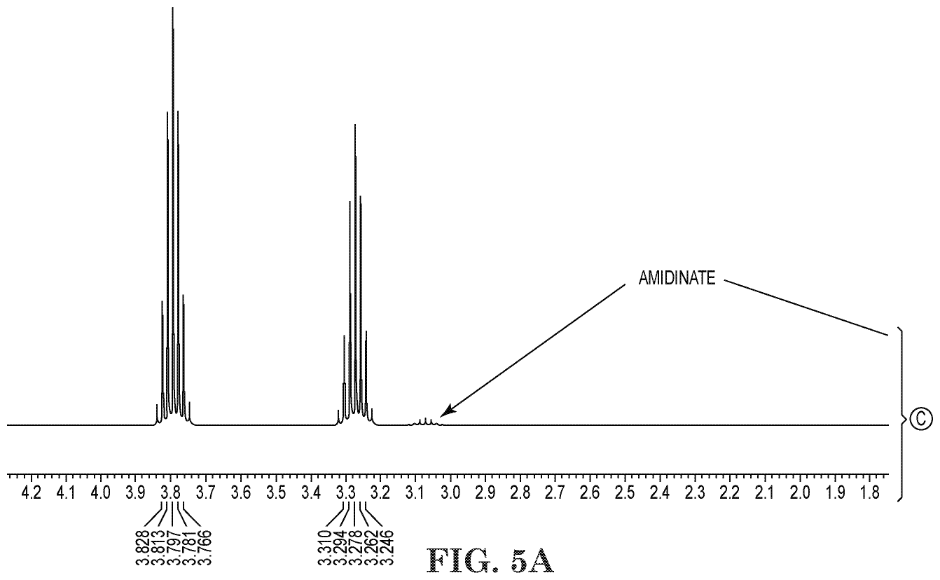

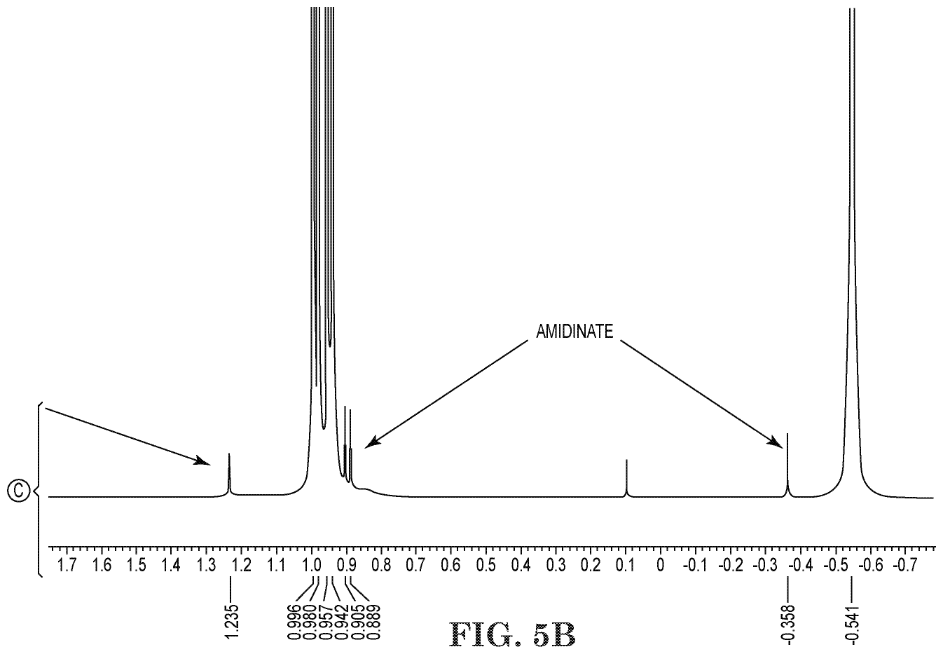

FIG. 5 is a graphical representation of a ¹H NMR spectrum of a composition, according to some embodiments. A composition, according to some embodiments, described herein, comprising dimethylaluminum isopropoxide (DMAI) and trimethylaluminum (TMA) was prepared. The composition was contacted with carbodiimide compound in stoichiometric excess at room temperature for over 24 hours. The composition was analyzed using ¹H NMR to determine a purity of the dimethylaluminum isopropoxide. As shown in FIG. 3, the aluminum amidinate compound peaks are identified.

### Aspects

Various Aspects are described below. It is to be understood that any one or more of the features recited in the following Aspect(s) can be combined with any one or more other Aspect(s).
Aspect 1. A method comprising:
   contacting a composition comprising a reaction product and an alkyl aluminum compound, with a carbodiimide compound, to form an aluminum amidinate,
      wherein the carbodiimide compound selectively reacts with the alkyl aluminum compound over the reaction product; and
   analyzing the composition to determine a purity of the reaction product.
Aspect 2. The method according to Aspect 1, wherein the reaction product comprises a compound of the formula:

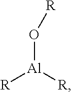

where:
   R independently comprises an alkyl.
Aspect 3. The method according to any one of Aspects 1-, wherein the alkyl aluminum compound comprises a compound of the formula:

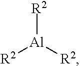

where:
   R² independently comprises an alkyl.
Aspect 4. The method according to any one of Aspects 1-3, wherein the carbodiimide compound comprises a compound of the formula:

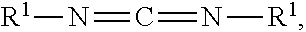

where:
   R¹ independently comprises an alkyl.
Aspect 5. The method according to any one of Aspects 1-4, wherein the aluminum amidinate comprises a compound of the formula:

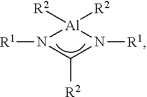

where:
   R¹ independently comprises an alkyl; and
   R² independently comprises an alkyl.
Aspect 6. The method according to any one of Aspects 1-5, wherein the analyzing is conducted using ¹H NMR to determine the purity of the reaction product.
Aspect 7. The method according to any one of Aspects 1-6, wherein the analyzing is conducted using gas chromatography.
Aspect 8. The method according to any one of Aspects 1-7, wherein the analyzing is conducted using at least one of at least one of Gas Chromatography-Mass Spectrometry (GC-MS), Gas Chromatography-Flame Ionization Detector (GC-FID), Gas Chromatography-Thermal Conductivity Detector (GC-TCD), Gas Chromatography-Electron Capture Detector (GC-ECD), or any combination thereof.
Aspect 9. The method according to any one of Aspects 1-8, wherein the contacting comprises adding the carbodiimide compound to the composition in stoichiometric excess of the alkyl aluminum compound.
Aspect 10. A method comprising:
   contacting an alkyl aluminum compound with a reagent to form a composition comprising a reaction product and an unreacted alkyl aluminum compound;
   contacting the composition with a carbodiimide compound to form an aluminum amidinate,
      wherein the carbodiimide compound selectively reacts with the unreacted alkyl aluminum compound over the reaction product; and
   analyzing the composition to determine a purity of the reaction product.
Aspect 11. The method according to Aspect 10, wherein the reaction product comprises a dimethylaluminum isopropoxide (DMAI), comprising the formula:

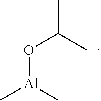

Aspect 12. The method according to any one of Aspects 10-11, wherein the alkyl aluminum compound comprises a trimethylaluminum compound of the formula:

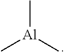

Aspect 13. The method according to any one of Aspects 10-12, wherein the carbodiimide compound comprises a compound of the formula:

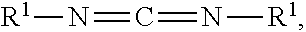

where:
   R¹ independently comprises a C₃-C₆ alkyl.
Aspect 14. The method according to any one of Aspects 10-13, wherein the aluminum amidinate comprises a compound of the formula:

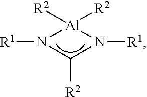

where:
   R¹ independently comprises a C₃-C₆ alkyl; and
   R² independently comprises a C₁-C₃ alkyl.
Aspect 15. The method according to any one of Aspects 10-14, wherein the reagent comprises at least one of a 2-propanol, an aluminum isopropoxide, or any combination thereof.
Aspect 16. The method according to any one of Aspects 10-15, wherein the analyzing is conducted using ¹H NMR to determine the purity of the reaction product.
Aspect 17. The method according to any one of Aspects 10-16, wherein the analyzing is conducted using gas chromatography.
Aspect 18. The method according to any one of Aspects 10-17, wherein the analyzing is conducted using at least one of at least one of Gas Chromatography-Mass Spectrometry (GC-MS), Gas Chromatography-Flame Ionization Detector (GC-FID), Gas Chromatography-Thermal Conductivity Detector (GC-TCD), Gas Chromatography-Electron Capture Detector (GC-ECD), or any combination thereof.
Aspect 19. A composition comprising:
   an aluminum precursor,
      wherein the aluminum precursor comprises a compound of the formula:

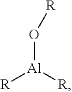

where:
   each R is independently an alkyl;
5% by weight or less of an alkyl aluminum compound based on a total weight of the composition.
Aspect 20. The composition according to Aspect 19, wherein the composition comprises less than 1% by weight of the alkyl aluminum compound based on the total weight of the composition.
Aspect 21. An article comprising:
   a substrate,
      wherein the substrate has:
         a first surface portion comprising a metal; and
         a second surface portion comprising a non-metal; and
   a layer,
      wherein the layer comprises a reaction product,
         wherein the reaction product comprises a compound of the formula:

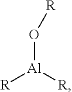

where:
each R is independently an alkyl; and
wherein the layer is located on the second surface portion.

What is claimed is:

1. A method comprising:
contacting a composition comprising a reaction product and an alkyl aluminum compound, with a carbodiimide compound, to form an aluminum amidinate,
wherein the carbodiimide compound selectively reacts with the alkyl aluminum compound over the reaction product; and
analyzing the composition to determine a purity of the reaction product.

2. The method of claim 1, wherein the reaction product comprises a compound of the formula: 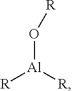
where:
R independently comprises an alkyl.

3. The method of claim 1, wherein the alkyl aluminum compound comprises a compound of the formula: 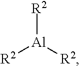
where:
R² independently comprises an alkyl.

4. The method of claim 1, wherein the carbodiimide compound comprises a compound of the formula: 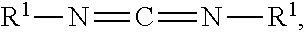
where:
R¹ independently comprises an alkyl.

5. The method of claim 1, wherein the aluminum amidinate comprises a compound of the formula: 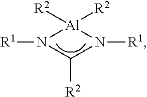
where:
R¹ independently comprises an alkyl; and
R² independently comprises an alkyl.

6. The method of claim 1, wherein the analyzing is conducted using ¹H NMR to determine the purity of the reaction product.

7. The method of claim 1, wherein the analyzing is conducted using gas chromatography.

8. The method of claim 1, wherein the analyzing is conducted using at least one of at least one of Gas Chromatography-Mass Spectrometry (GC-MS), Gas Chromatography-Flame Ionization Detector (GC-FID), Gas Chromatography-Thermal Conductivity Detector (GC-TCD), Gas Chromatography-Electron Capture Detector (GC-ECD), or any combination thereof.

9. The method of claim 1, wherein the contacting comprises adding the carbodiimide compound to the composition in stoichiometric excess of the alkyl aluminum compound.

10. A method comprising:
contacting an alkyl aluminum compound with a reagent to form a composition comprising a reaction product and an unreacted alkyl aluminum compound;
contacting the composition with a carbodiimide compound to form an aluminum amidinate,
wherein the carbodiimide compound selectively reacts with the unreacted alkyl aluminum compound over the reaction product; and
analyzing the composition to determine a purity of the reaction product.

11. The method of claim 10, wherein the reaction product comprises a dimethylaluminum isopropoxide (DMAI), comprising the formula:

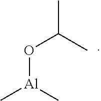

12. The method of claim 10, wherein the alkyl aluminum compound comprises a trimethylaluminum compound of the formula:

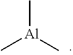

13. The method of claim 10, wherein the carbodiimide compound comprises a compound of the formula: 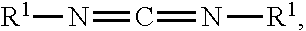
where:
R¹ independently comprises a C₃-C₆ alkyl.

14. The method of claim 10, wherein the aluminum amidinate comprises a compound of the formula: 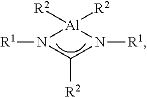
where:
R¹ independently comprises a C₃-C₆ alkyl; and
R² independently comprises a C₁-C₃ alkyl.

15. The method of claim 10, wherein the reagent comprises at least one of a 2-propanol, an aluminum isopropoxide, or any combination thereof.

16. The method of claim 10, wherein the analyzing is conducted using ¹H NMR to determine the purity of the reaction product.

17. The method of claim 10, wherein the analyzing is conducted using gas chromatography.

18. The method of claim 10, wherein the analyzing is conducted using at least one of at least one of Gas Chromatography-Mass Spectrometry (GC-MS), Gas Chromatography-Flame Ionization Detector (GC-FID), Gas Chromatography-Thermal Conductivity Detector (GC-TCD), Gas Chromatography-Electron Capture Detector (GC-ECD), or any combination thereof.

19. A composition comprising:
an aluminum precursor,
wherein the aluminum precursor comprises a compound of the formula: 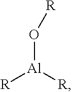
where:
each R is independently an alkyl;
5% by weight or less of an alkyl aluminum compound based on a total weight of the composition.

20. The composition of claim 19, wherein the composition comprises less than 1% by weight of the alkyl aluminum compound based on the total weight of the composition.

21. An article comprising:
a substrate,
wherein the substrate has:
a first surface portion comprising a metal; and
a second surface portion comprising a non-metal; and
a layer,
wherein the layer comprises a reaction product,
wherein the reaction product comprises a compound of the formula: 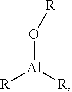
where:
each R is independently an alkyl; and
wherein the layer is located on the second surface portion.
